(19) United States
(12) Patent Application Publication
(10) Pub. No.: US 2005/0049943 A1
(43) Pub. Date: Mar. 3, 2005

(54) Inventory management system and method including real-time alarms

(76) Inventors: Sheng Chi Luo, Tu-Chen (TW); QiongShuai Chen, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/920,761

(22) Filed: Aug. 17, 2004

(30) Foreign Application Priority Data
Aug. 27, 2003 (TW) 92123528

(51) Int. Cl. G06F 17/60

(52) U.S. Cl. 705/28

(57) ABSTRACT

An inventory management system includes a plurality of corporation client computers (10), a corporation website (13), a server (12), and a database (15). Each corporation client computer provides an interactive user interface for user to perform inventory management. The corporation website is connected to the server, and provides an operating platform for inventory management. The server includes a plurality of function modules for timely managing inventory information, in order to control procurement operations and automatically generate alarm signals when inventory abnormalities occur. The database stores inventory information including material names, material quantities, storage locations, serial numbers for the storage locations, inventory ages, and names of suppliers. A related inventory management method is also disclosed.

### BACKGROUND OF THE INVENTION

1. Field of the Invention

The present invention relates to inventory management systems and methods, and particularly to a inventory management system and method including real-time alarms.

2. Background of the Invention

A mass producer of appliances must efficiently coordinate almost countless component parts. Many appliances are made up of a great number of parts. The various parts are stored in a storehouse in advance, collected by an inventory clerk according to need, and conveyed to a workshop at which the appliances are assembled. Conventional methods of storing and collecting necessary parts are rather inefficient. These procedures involve a large number of manual tasks, such as confirming inventory information and confirming part numbers. These manual steps are not only time consuming, but also often lead to human error in the inventory results. Thus, computer-based inventory management systems are now rapidly gaining in popularity.

Automated inventory management systems are disclosed in a number of patents. U.S. Pat. No. 6,418,416 issued on Jul. 9, 2002 and entitled “Inventory Management System and Method” discloses a system and a method for analyzing optimal inventory levels by tracking inventory and generating statements. A warehouse-keeper can ascertain up-to-date inventory statuses by searching a database. However, the system and method are basically limited to managing inventory quantities, and cannot properly manage other inventory information. In particular, the system cannot timely display problems that arise during inventory management. This can result in overstocking of materials and increased inventory costs.

### SUMMARY OF THE INVENTION

Accordingly, a main objective of the present invention is to provide an inventory management system and method including real-time alarms in which users can conveniently manage inventory by way of searching for inventory quantities for materials, analyzing inventory ages for the materials, recording inventory variations, and timely transmitting alarm signals to corresponding operators.

To accomplish the above objective, a inventory management system in accordance with a preferred embodiment of the present invention comprises a plurality of corporation client computers, a corporation website, a server, and a database. Each corporation client computer provides an interactive user interface for users to operate inventory management. The corporation website is for providing an operation platform for inventory management. The server is for timely managing inventory information, in order to control procurement operations and automatically generate alarm signals when inventory abnormalities occur. The server comprises: an inventory information maintaining module for maintaining inventory information; an inventory status recording module for automatically recording inventory information; and an alarm signal generating module for automatically generating an alarm signal when inventory abnormalities occur, and for transmitting the alarm signals to one or more corresponding operators. The database stores inventory information used or generated in implementing the system. Such information comprises material names, material quantities, storage locations, serial numbers for the storage locations, inventory ages, and names of suppliers.

Further, the present invention provides a inventory management method, comprising the steps of: (a) searching for inventory quantities for various materials; (b) recording the inventory information and generating statistical statements according to the inventory information; (c) determining whether the inventory quantity for any material exceeds its preset inventory threshold, and generating an alarm signal in respect of the material and transmitting the alarm signal to one or more corresponding operators if the inventory quantity of any material exceeds its preset inventory threshold; (d) calculating one or more inventory ages for each material if the inventory quantity of any material does not exceed its preset inventory threshold; (e) determining whether any material comprises dead stock, based on the inventory ages of the material, and generating an alarm signal in respect of the material and transmitting the alarm signal to corresponding operators if any material comprises dead stock; (f) recording any inventory variation occurring in any storage location; and (g) determining whether any inventory variation is abnormal, and generating an alarm signal in respect of the material and transmitting the alarm signal to one or more corresponding operators if any inventory variation is abnormal.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a inventory management system in accordance with the preferred embodiment of the present invention;

FIG. 2 is a schematic diagram of main function modules of a server of the system of FIG. 1;

FIG. 3 is a schematic diagram of main function sub-modules of an inventory status recording module of the server of FIG. 2; and

FIG. 4 is a flowchart of a preferred method for implementing the system of FIG. 1.

### DETAILED DESCRIPTION OF THE INVENTION

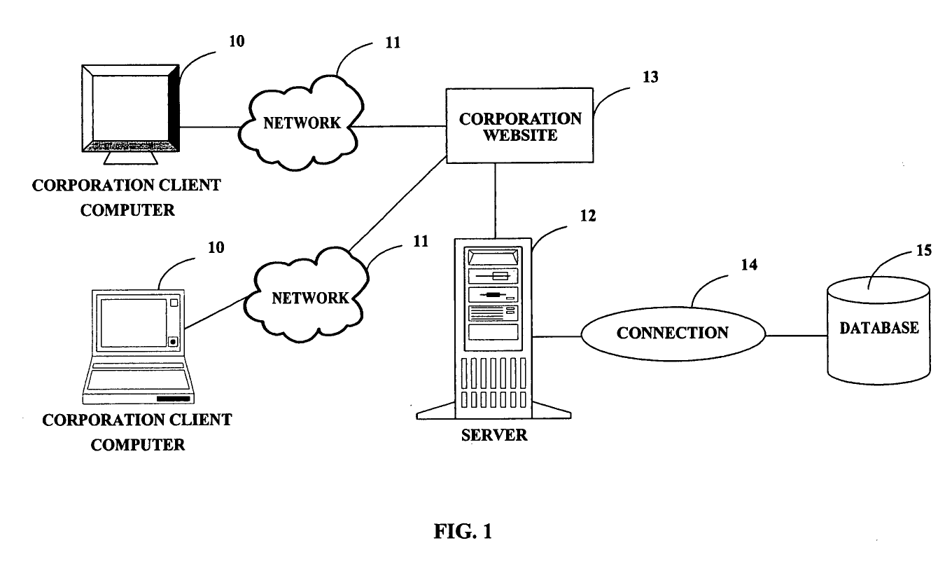

FIG. 1 is a schematic diagram of hardware infrastructure of a inventory management system in accordance with the preferred embodiment of the present invention. The system comprises a plurality of corporation client computers 10, a corporation website 13, a server 12, and a database 15. The client computers 10 are connected with the corporation website 13 through a network 11. The network 11 may be any suitable communication architecture required by the system, such as a local area network or a wide area network. The server 12 is connected with the database 15 via a connection 14. The connection 14 is a database connectivity such as an Open Database Connectivity (ODBC) or a Java Database Connectivity (JDBC). Each corporation client computer 10 provides an interactive user interface for users to perform inventory management. The corporation website 13 is connected to the server 12, and provides an operating platform for inventory management. The server 12 comprises a plurality of function modules for timely managing inventory information, in order to control procurement operations and automatically generate alarm signals when inventory abnormalities occur. The database 15 stores inventory information used or generated in implementing the system. Such information comprises material names, material quantities, storage locations, serial numbers for the storage locations, inventory ages, and names of suppliers.

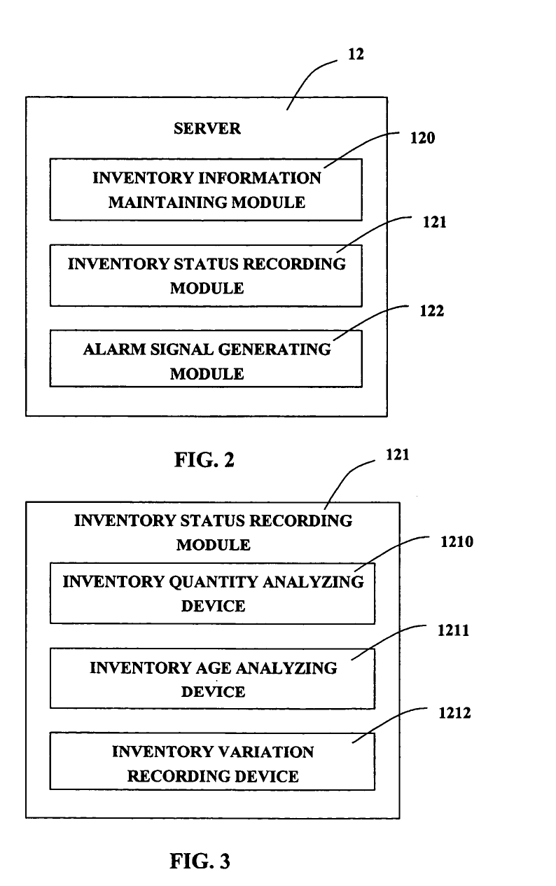

FIG. 2 is a schematic diagram of main function modules of the server 12. The server 12 comprises an inventory information maintaining module 120, an inventory status recording module 121, and an alarm signal generating module 122. The inventory information maintaining module 120 maintains all kinds of inventory information, including by way of adding, modifying, searching and deleting the inventory information. The inventory information includes inventory quantities, inventory ages, inventory variations, etc. Inventory variations occur when materials in storage locations are shipped to buyers, when the storage locations receive purchased materials or returned materials, and when operators in the storage locations process discards. The inventory status recording module 121 automatically records the above-described inventory information, and generates statistical statements according to the inventory information. The alarm signal generating module 122 automatically generates an alarm signal when inventory abnormalities occur, and transmits the alarm signals to one or more corresponding operators such as inventory managers and department executives. Inventory abnormalities may include excess inventories, dead stocks, shipment abnormalities, and delivery abnormalities. Shipment abnormalities occur when shipment dates or quantities of shipped materials do not accord with planned shipment dates or quantities. Delivery abnormalities occur when delivery dates, delivery quantities or the quality of delivered materials do not accord with planned delivery dates, delivery quantities or the quality of delivered materials. The alarm signals can be transmitted to the operators through e-mails, mobile phone messages or voice messages.

FIG. 3 is a schematic diagram of main function sub-modules of the inventory status recording module 121. The inventory status recording module 121 comprises an inventory quantity analyzing device 1210, an inventory age analyzing device 1211, and an inventory variation recording device 1212. The inventory quantity analyzing device 1210 analyzes inventory quantities for the materials, and determines whether a current inventory quantity for any material exceeds its preset inventory threshold. The inventory age analyzing device 1211 calculates one or more inventory ages for each material, and determines whether any material comprises dead stock. Inventory age for a material can be calculated by subtracting a time of initial warehousing of the material from a current time. For a material already shipped to a buyer, the inventory age can be calculated by subtracting an initial warehousing time from a shipment time. Each material has a preset standard maximum acceptable inventory age. If the calculated inventory age of any material exceeds its standard inventory age, the material is considered a dead stock. The inventory age analyzing device 1211 can also integrate analysis results of inventory ages into statistical statements, and store the statistical statements in the database 15. Information on dead stocks is transmitted to the alarm signal generating module 122. Such information comprises names and quantities for dead stocks, and serial numbers of the storage locations that store the dead stocks. The inventory variation recording device 1212 automatically records inventory variations occurring in storage locations, and integrates the inventory variations into statistical statements. The statistical statements are stored in the database 15. Information on inventory abnormalities is transmitted to the alarm signal generating module 122.

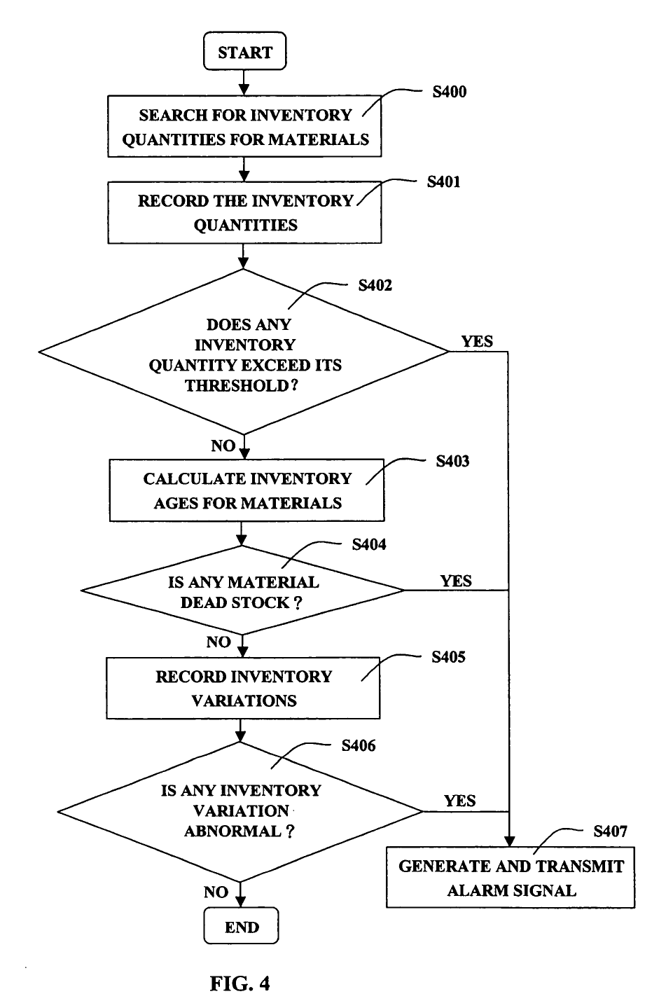

FIG. 4 is a flowchart of a preferred method for implementing the inventory management system according to the present invention. In step S400, the inventory analyzing device 1210 searches for inventory quantities for various materials. In step S401, the inventory status recording module 121 records the above-described inventory information, and generates statistical statements according to the inventory information. In step S402, the inventory quantity analyzing device 1210 analyzes the a inventory quantity for any material, and determines whether the inventory quantity for any material exceeds its preset inventory threshold. If the inventory quantity of any material exceeds its preset inventory threshold, the procedure goes directly to step S407 in respect of that material, as described below. If the inventory quantity of any material does not exceed its preset inventory threshold, the procedure goes directly to step S403 in respect of that material. In step S403, the inventory age analyzing device 1211 calculates one or more inventory ages for each material. In step S404, the inventory age analyzing device 1211 determines whether any material comprises dead stock, based on the inventory ages of the material. If there any material comprises dead stock, the procedure goes directly to step S407 in respect of that material, as described below. If any material does not comprise dead stock, the procedure goes directly to step S405 in respect of that material. In step S405, the inventory variation recording device 1212 automatically records any inventory variations occurring in any storage location, and integrates the inventory variations into statistical statements. The statistical statements are stored in the database 15. In step S406, the inventory variation recording device 1212 determines whether any inventory variation is abnormal. If any inventory variation is abnormal, the procedure goes directly to step S407 in respect of that material, as described below. If any inventory variation is not abnormal, the procedure is ended in respect of that material. In step S407, the alarm signal generating module 122 automatically generates an alarm signal in respect of the material, and transmits the alarm signal to one or more corresponding operators.

Although the present invention has been specifically described on the basis of a preferred embodiment and a preferred method, the invention is not to be construed as being limited thereto. Various changes and modifications may be made to the embodiment and method without departing from the scope and spirit of the invention.

1. An inventory management system comprising:
a plurality of corporation client computers, each corporation client computer providing an interactive user interface for users to perform inventory management; and
a server, comprising:
an inventory information maintaining module for maintaining inventory information;
an inventory status recording module for automatically recording inventory information; and
an alarm signal generating module for automatically generating alarm signals when inventory abnormalities occur, and for transmitting the alarm signals to one or more corresponding operators; and
a database for storing inventory information.

2. The inventory management system according to claim 1, wherein the inventory status recording module comprises:
an inventory quantity analyzing device for analyzing inventory quantities for the materials, and for determining whether a current inventory quantity for any material exceeds its preset inventory threshold;
an inventory age analyzing device for calculating one or more inventory ages for each material, and determining whether any material comprises dead stock; and
an inventory variation recording device for automatically recording inventory variations occurring in storage locations.

3. The inventory management system according to claim 2, wherein an inventory age for a material can be calculated by subtracting a time of initial warehousing of the material from a current time, and for a material already shipped to a buyer, an inventory age can be calculated by subtracting an initial warehousing time from a shipment time.

4. The inventory management system according to claim 2, wherein the inventory variations occur when materials in storage locations are shipped to buyers, when the storage locations receive purchased materials or returned materials, and when operators in the storage locations process discards.

5. The inventory management system according to claim 1, wherein the inventory abnormalities include excess inventories, dead stocks, shipment abnormalities, and delivery abnormalities.

6. The inventory management system according to claim 1, wherein the alarm signals are transmitted to the operators through e-mails, mobile phone messages or voice messages.

7. A computer-based inventory management method, comprising the steps of:
searching for inventory quantities for various materials;
recording the inventory information and generating statistical statements according to the inventory information;
determining whether the inventory quantity for any material exceeds its preset inventory threshold, and generating an alarm signal in respect of the material and transmitting the alarm signal to one or more corresponding operators if the inventory quantity of any material exceeds its preset inventory threshold;
calculating one or more inventory ages for each material if the inventory quantity of any material does not exceed its preset inventory threshold;
determining whether any material comprises dead stock, based on the inventory ages of the material, and generating an alarm signal in respect of the material and transmitting the alarm signal to one or more corresponding operators if any material comprises dead stock;
recording any inventory variation occurring in any storage location; and
determining whether any inventory variation is abnormal, and generating an alarm signal in respect of the material and transmitting the alarm signal to one or more corresponding operators if any inventory variation is abnormal.

8. The method according to claim 7, wherein an inventory age for a material can be calculated by subtracting a time of initial warehousing of the material from a current time, and for a material already shipped to a buyer, an inventory age can be calculated by subtracting an initial warehousing time from a shipment time.

9. The method according to claim 7, wherein each material has a preset standard maximum acceptable inventory age, and if a calculated inventory age of a material exceeds its preset standard maximum acceptable inventory age, the material is considered a dead stock.

10. The method according to claim 7, wherein the inventory variations occur when materials in storage locations are shipped to buyers, when the storage locations receive purchased materials or returned materials, and when operators in the storage locations process discards.

11. The method according to claim 7, wherein the inventory abnormalities include excess inventories, dead stocks, shipment abnormalities, and delivery abnormalities.

12. A computer-based inventory management method, comprising the steps of:
searching for inventory quantities for various materials;
recording the inventory information and generating statistical statements according to the inventory information;
determining whether the inventory quantity for any material exceeds its preset inventory threshold, and generating an alarm signal in respect of the material and transmitting the alarm signal to one or more corresponding operators if the inventory quantity of any material exceeds its preset inventory threshold;
calculating one or more inventory ages for each material if the inventory quantity of any material does not exceed its preset inventory threshold;
determining whether any material comprises dead stock, based on the inventory ages of the material, and generating an alarm signal in respect of the material and transmitting the alarm signal to one or more corresponding operators if any material comprises dead stock.
